(19) United States
(12) Patent Application Publication
(10) Pub. No.: US 2009/0122559 A1
(43) Pub. Date: May 14, 2009

(54) EXTERNAL LIGHT BLOCKING FILM AND FILTER FOR DISPLAY DEVICE HAVING THE SAME

(76) Inventors: Eun Young Cho, Asan-si (KR); In Sung Sohn, Asan-si (KR); Seong-sik Park, Asan-si (KR)

Correspondence Address: MCDERMOTT WILL & EMERY LLP, 600 13TH STREET, N.W., WASHINGTON, DC, 20005-3096, US

(21) Appl. No.: 12/253,429

(22) Filed: Oct. 17, 2008

(30) Foreign Application Priority Data
Oct. 18, 2007 (KR) 10-2007-0105259

(51) Int. Cl. F21V 5/00

(52) U.S. Cl. 362/326

(57) ABSTRACT

An external light blocking film includes a base transmitting external light, and an external light blocking pattern which blocks the external light and is formed at the base. A refraction index of the base is larger than a refraction index of air by more than 0 and not more than 0.56. The base satisfies the following equation: 0°<(θ1−θ2)≦35°, where θ1 is an incident angle at which the external light is incident onto the base, and θ2 is an refraction angle at which the external light refracts due to a difference between the refraction index of the base and the refraction index of air.

### CROSS-REFERENCE TO RELATED APPLICATION

This application claims the benefit of Korean Patent Application No. 2007-0105259 filed on Oct. 18, 2007 with the Korean Intellectual Property Office, the disclosure of which is incorporated herein by reference.

### BACKGROUND OF THE INVENTION

1. Field of the Invention

The present invention relates to an external light blocking film and a filer for a display device having the same.

2. Description of the Related Art

Display devices include televisions, monitors of personal computers, portable display devices, and so on. The display devices are recently getting larger sized and thinner.

Accordingly, flat panel display (FPD) devices such as plasma display panel (PDP) devices, liquid crystal display (LCD) devices, field emission display (FED) devices, and organic light emitting display (OLED) devices take the place of for cathode ray tube (CRT) device, which was representative of display devices.

Hereinafter, the PDP devices and a filter therefor will be exemplified but the present invention is not limited thereto. For example, a filter according to the present invention can be used for large sized display devices such as the OLED devices, the LCD devices and the FED devices; small sized display devices such as Personal Digital Assistance (PDA) devices, display devices for small sized games, display devices for small mobile phones; and flexible display devices.

Especially, the PDP device is in the limelight since it has excellent display characteristics such as a high luminance, a high contrast ratio, a low after-image, and a wide viewing angle.

The PDP device causes gas discharge between electrodes by applying a direct or alternating voltage to the electrodes, then fluorescent material is activated by ultraviolet radiation caused by the gas discharge, and thereby light is generated. The PDP device displays images by using the generated light.

However, the PDP device has drawbacks that a large amount of electromagnetic waves and near infrared rays is emitted due to its intrinsic characteristics. The electromagnetic waves and near infrared rays emitted from the PDP device may have a harmful effect to the human body, and cause malfunction of precision appliances such as a cellular phone and a remote controller. Further, the PDP device has a high surface reflection and has lower color purity than the CRT device due to orange color light emitted from gas such as He or Xe.

Therefore, the PDP device employs a PDP filter in order to block electromagnetic waves and near infrared rays, reduce light reflection, and improve color purity. The PDP filter is installed in front of a panel assembly. The PDP filter is generally manufactured by adhering or bonding a plurality of functional layers such as an electromagnetic wave blocking layer, etc.

Especially, the PDP filter can include an external light blocking film which blocks external light by its external light blocking pattern.

However, the PDP filter of the related art has problems that the external light blocking film has a poor external light blocking ability and thus the PDP device has a poor Contrast Ratio (CR).

### SUMMARY OF THE INVENTION

The present invention is intended to solve the foregoing problems with the related art, and therefore an object of the present invention is to provide an external light blocking film and a filter with an excellent contrast ratio.

To achieve the above object, the present invention provides an external light blocking film including: a base transmitting external light and an external light blocking pattern which blocks the external light and is formed at the base, wherein a refraction index of the base is larger than a refraction index of air by more than 0 and not more than 0.56, and the base satisfies the following equation: 0°<(θ1−θ2)≦35°, where θ1 is an incident angle at which the external light is incident onto the base, and θ2 is an refraction angle at which the external light refracts due to a difference between the refraction index of the base and the refraction index of air.

In addition, the present invention provides a filter for a display device having the external light blocking film.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating an external light blocking film according to one embodiment of the present invention;

FIG. 2 is a cross-sectional view illustrating the external light blocking film in FIG. 1;

FIG. 3 shows a simulation result showing relationship between a luminous density and a vertical viewing angle;

FIG. 4 is a cross-sectional view illustrating a filter for a display device; and

FIG. 5 is a cross-sectional view illustrating a display device.

### DETAILED DESCRIPTION OF THE EXEMPLARY EMBODIMENT

The present invention will now be described more fully hereinafter with reference to the accompanying drawings, in which exemplary embodiments thereof are shown. In the following Detailed Description, a detailed description of known functions and components will be omitted.

In the Detailed Description, an external light blocking film and a filter for a PDP device is exemplified but the scope of the present invention should not be limited thereto.

For example, an external light blocking film and a filter according to the present invention can be used for other flat panel display devices such as an LCD device, a field emission display device, an organic light emitting display device, and so on as well as a PDP device.

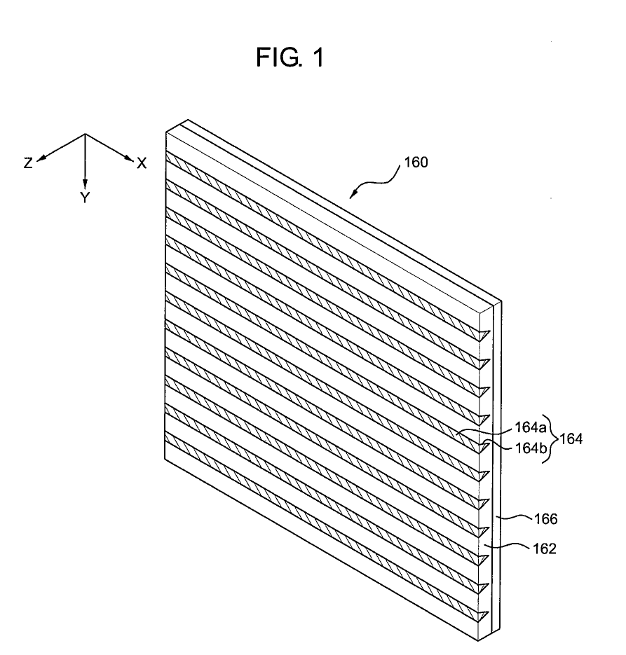

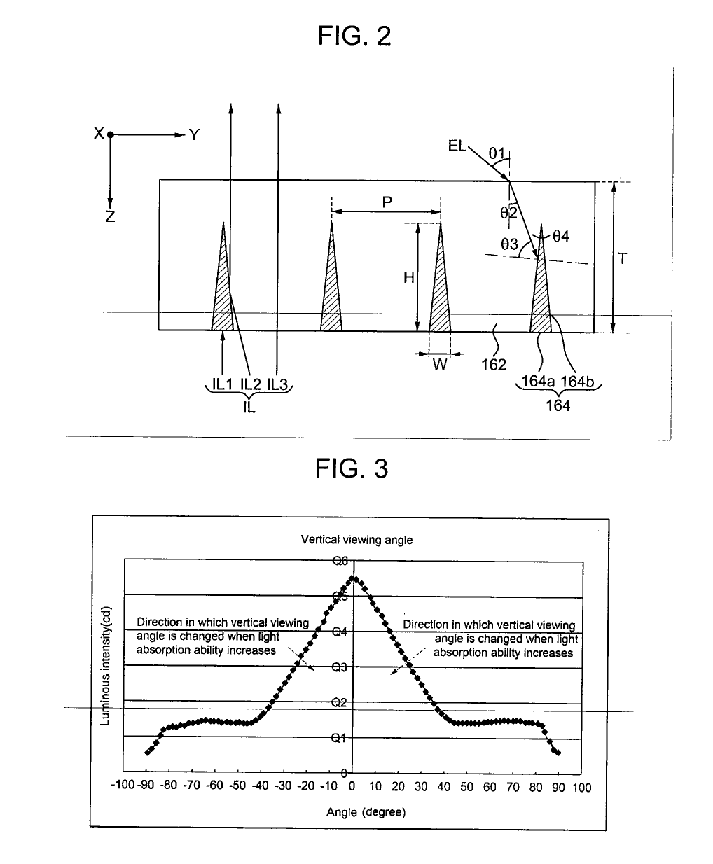

FIG. 1 is a perspective view illustrating an external light blocking film 160 according to one embodiment of the present invention. FIG. 2 is a cross-sectional view illustrating the external light blocking film 160 in FIG. 1 but a backing 166 depicted in FIG. 1 is omitted for convenience' sake.

Referring to FIG. 1 and FIG. 2, the external light blocking film 160 includes a base 162 and an external light blocking pattern 164 formed at the base 162. FIG. 1 and FIG. 2 show that the external light blocking pattern 164 is formed on one surface of the base 162. However, according to another embodiment, external light blocking patterns 164 can be formed on both surfaces of the base 162 or in the base 162.

The external light blocking film 160 can include the backing 166 formed on the base 162. The backing 166 performs a function of supporting the base 162 on which the external light blocking pattern 164 is formed. However, according to another embodiment, the backing 166 can be excluded from the external light blocking film 160.

External light which travels through the air and then is incident onto the base 162 is transmitted through the base 162. The base 162 can include a transparent resin with a low refraction index. Here, “low refraction index” means a refraction index of more than 1 and not more than 1.56. Since the refraction index of ambient air is about 1, the refraction index of the base 162 is larger than that of ambient air by more than 0 and not more than 0.56.

A variety of materials can be used for the base 162, as long as they satisfy such requirements of transparency and a refraction index. For example, a denatured fluorine resin can be used for the base 162.

The denatured fluorine resin is a compound in the form of a monomer or an oligomer which is obtained by a reaction between a compound having a fluorine substituent and a compound having a light-curable functional group.

Here, the compound having the fluorine substituent includes fluoroolefin (for example, fluoroethylene, fluorovinyliden, tetrafluoroethylene, hexafluoroethylene, hexafluoropropylene, perfluoro-2,2-dimethyl-1,3-dioxol), fluoro (meta)acrylate ester, fluoro alkyl (meta)acrylic, fluoro vinylether, etc. The compound having the light-curable functional group includes (meta)acrylate having an epoxy group, (meta)acrylate having a carboxyl group, (meta)acrylate having a hydroxyl group, (meta)acrylate having an amino group, (meta)acrylate having sulfonic acid, etc.

More preferably, a denatured fluorine multifunctional acrylate which is obtained by a reaction between a compound having perfluoro polyether and a multifunctional acrylate can be used as the denatured fluorine resin.

The external light blocking pattern 164 can absorb external light which travels through the air and is incident onto the base 162, and then is refracted due to the difference between the refraction index of air and the refraction index of the base 162. When the external light blocking film 160 is installed in front of a panel assembly of a PDP device, the external light blocking pattern 164 blocks a part of light (IL1), and totally reflects a part of light (IL2) among light (IL) emitted from a panel assembly.

This enables the external light blocking pattern 164 to improve a contrast ratio, especially a bright room contrast ratio of a PDP device. An unexplained reference numeral IL3 denotes a part of light straightly transmitted through the external light blocking film 160 among light (IL) emitted from a panel assembly.

The external light blocking pattern 164 can have bottom surfaces 164a and slant surfaces 164b. The slant surfaces 164b slantingly extend from the bottom surfaces 164a in an inward direction of the external light blocking film 160, that is, in the −Z direction to form wedge shapes. The external light blocking pattern 164 is formed in the shape of stripes each of which extends along an X-axis. In this embodiment, the bottom surface 164a is exposed to the outside to form a part of a surface of the base 162. The symmetrical slant surfaces 164b are exemplified in this embodiment but the slant surfaces 164b can also be asymmetrical.

A shape of the external light blocking pattern 164 is not limited to the above-mentioned shape. For example, the external light blocking pattern 164 can be formed to protrude from a surface of the base 162. In addition, the external light blocking pattern 164 can have a uniform or random curvature in the X-direction. The external light blocking pattern 164 can have a shape of triangle, trapezoid, partial arc or partial oval on a Y-Z plane, that is, on a cross-sectional plane of the external light blocking film 160.

In order to effectively blocking external light (EL), it is better that the ratio of height (H) to width (W) (that is, H/W) is large. Considering a thickness of the base 162 and a pitch of the external light blocking pattern 164 as well, the ratio of height to width can be given more than 4.

A refraction index of the external light blocking pattern 164 can be more than, equal to or less than the refraction index of the base 162. Preferably, the refraction index of the external light blocking pattern 164 can be lower than the refraction index of the base 162 by not less than 0 and not more than 0.5. The lower refraction index of the external light blocking pattern 164 enables the external light blocking pattern 164 to totally reflect the part of light (IL2) emitted from the panel assembly, whereby an excellent contrast ratio can be obtained. However, if the refraction index of the external light blocking pattern 164 is extremely low, available material is extremely limited and twin image (Ghost) can be caused. Therefore, it is preferable that the refraction index of the external light blocking pattern 164 is within the above mentioned range.

The external light blocking pattern 164 can include 100 parts by weight of a light curable resin and 0.5˜10 parts by weight of a colorant. It can further include a light curing initiator and a light stabilizer.

For example, a urethane type resin or an acrylic type resin having refraction indices of 1.35 to 1.5 can be used as the light curable resin.

The colorant performs a function of absorbing the external light (EL) to block it. If an amount of the colorant is less than 0.5 parts by weight, degree of blocking the external light (EL) is small. On the other hand, if an amount of the colorant is more than 10 parts by weight, a vertical viewing angle decreases as shown in FIG. 3. FIG. 3 shows a simulation result showing relationship between a luminous density and a vertical viewing angle. As shown in FIG. 3, the vertical viewing angle in the form of Gaussian function decreases as luminous intensity increases.

In the embodiment of the present invention, it is possible to improve a contrast ratio by using difference between the refraction index of the base 162 and the refraction index of ambient air and difference between the incident angle at which the external light is incident onto the base 162 and the refraction angle which is caused by the difference in the refraction indices. In order to demonstrate more definitely, a simulation was carried out. Table 1 shows results of the simulation in which the incident angle θ1 of the external light (EL) was given 40 degrees. As shown in Table 1, the refraction angle θ2 changes according to the refraction index n1 of the base 162.

TABLE 1

| Incident | Refraction | Refraction |
|---|---|---|
| Angle | Index | Angle |
| (θ1) | (n1) | (θ2) |
| 40 | 1.56 | 24.3 |
| 40 | 1.54 | 24.7 |
| 40 | 1.52 | 25.0 |
| 40 | 1.50 | 25.4 |
| 40 | 1.48 | 25.7 |
| 40 | 1.46 | 26.1 |
| 40 | 1.44 | 26.5 |
| 40 | 1.42 | 26.9 |
| 40 | 1.40 | 27.3 |
| 40 | 1.38 | 27.8 |
| 40 | 1.36 | 28.2 |
| 40 | 1.34 | 28.7 |
| 40 | 1.32 | 29.1 |
| 40 | 1.30 | 29.6 |
| 40 | 1.28 | 30.1 |
| 40 | 1.26 | 30.7 |
| 40 | 1.24 | 31.2 |
| 40 | 1.22 | 31.8 |
| 40 | 1.20 | 32.4 |
| 40 | 1.18 | 33.0 |
| 40 | 1.16 | 33.7 |
| 40 | 1.14 | 34.3 |
| 40 | 1.12 | 35.0 |
| 40 | 1.10 | 35.8 |
| 40 | 1.08 | 36.5 |
| 40 | 1.06 | 37.3 |
| 40 | 1.04 | 38.2 |
| 40 | 1.02 | 39.1 |

Referring to FIG. 2 and Table 1, if the incident angle θ1 at which the external light is incident onto the base 162 is constant, the refraction angle θ2 increases as the refraction index of the base 162 decreases. In addition, an incident angle θ3 at which a refracted external light is incident onto the external light blocking pattern 164 decreases accordingly. This enables the external light to be effectively absorbed by the external light blocking pattern 164.

Here, since there is an unwelcome possibility that the refracted external light is not absorbed but totally or partially reflected by the external light blocking pattern 164 due to difference between the index of the base 162 and the index of the external light blocking pattern 164, it is required to satisfy the following Equation.

0°<(θ1−θ2)≦35°

On the other hand, the contrast ratio is also affected by light absorption ability and shape of the external light blocking pattern 164.

In order to demonstrate more definitely, a simulation was carried out. Table 2 shows results of the simulation. A width, a height, a pitch, and a wedge angle θ4 of the external light blocking pattern 164 was given 22 μm, 102.2 μm, 73.4 μm, and 4.5 degrees, respectively. In Table 2, values of light absorption ability are relative values.

TABLE 2

| | Light absorption | Refraction | Contrast |
|---|---|---|---|
| | ability | index (n1) | Ratio |
| #1 | 30 | 1.56 | 211.3:1 |
| #2 | 30 | 1.36 | 212.2:1 |
| #3 | 100 | 1.56 | 315.4:1 |
| #4 | 100 | 1.46 | 385.4:1 |

Referring to FIG. 2 and Table 2, the contrast ratio increases as the light absorption ability of the external light blocking pattern 164 increases. As shown in Table 2, provided the external light blocking pattern 164 has a low light absorption ability like 30, the contrast ratio increases only by 0.9 as the refraction index decreases by 0.2. Meanwhile, provided the external light blocking pattern 164 has a high light absorption ability like 100, the contrast ratio increases by 70 as the refraction index decreases only by 0.1.

In order to improve the light absorption ability, the external light blocking pattern 164 according to the embodiment of the present invention includes 100 pats by weight of the light curable resin and 0.5 to 10 parts by weight of the colorant.

Since the contrast ratio is affected by the shape of the external light blocking pattern 164 as well as the light absorption ability thereof, the external light blocking pattern 164 is so designed that a ratio of height to width is more than 4 in the embodiment of the present invention.

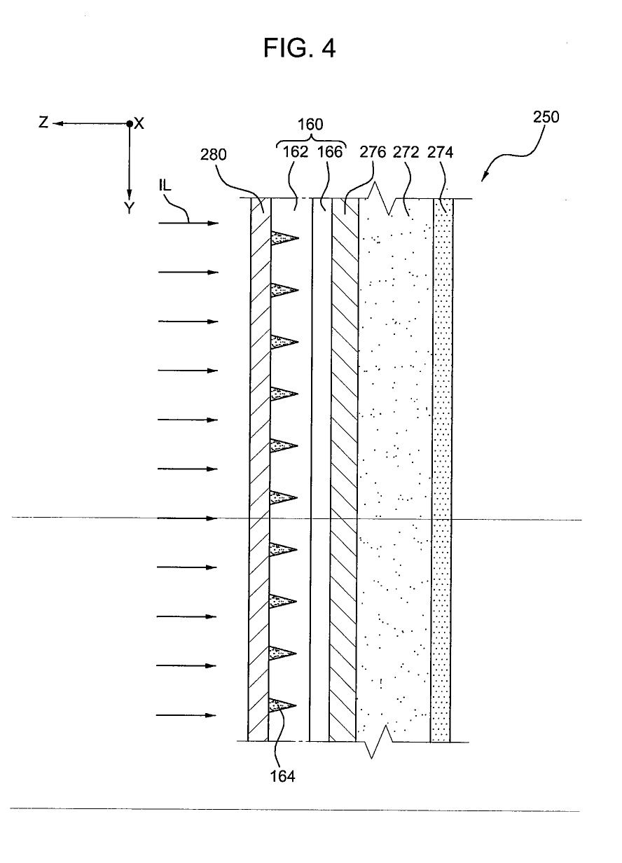

FIG. 4 shows a cross-sectional view illustrating a filter 250 for a display device. Since the external light blocking film 160 in FIG. 4 is the same as that in the above, the same reference numerals will be used and the same explanation will not be repeated.

Referring to FIG. 4, the filter 250 includes the external light blocking film 160. As shown in FIG. 4, the filter 250 can further include a transparent substrate 272, an anti-reflection layer 274, an electromagnetic wave blocking layer 276, and a color compensation layer 280. In addition, the filter 250 can include a variety of layers such as a near infrared ray blocking layer, a hard coating layer, and an anti-glare layer, although they are not depicted in FIG. 4.

FIG. 4 shows that the external light blocking film 160 is on the rear surface of the electromagnetic wave blocking layer 276. However, an order in which the layers stack can be varied. Each layer can adhere to or bond with an adjacent layer by means of an adhesive layer or a bonding layer. The adhesive layer or the bond layer can be provided with a color compensation colorant.

The anti-reflection layer 274 can reduce reflection of the external light to improve visibility.

The electromagnetic wave blocking layer 276 can effectively block electromagnetic waves generated by a panel assembly. The electromagnetic wave blocking layer 276 can be, for example, in the form of a film with a conductive mesh or a multi-layered transparent film. The multi-layered transparent film can have a near infrared ray blocking function.

In the above, the layers performing respective functions are described as being independent of one another, but the present invention is not limited thereto. For example, one hybrid layer can perform two functions.

The color compensation layer 280 can have transmittances of more than 60% within a wavelength range of 580 to 600 nm. The color compensation layer 280 reduces or adjusts an amount of Red/Green/Yellow light to change or correct color balance. However, in case that another layer performs a color compensation function, the color compensation layer 280 can be removed. The color compensation layer 280 can include a neon light cut colorant.

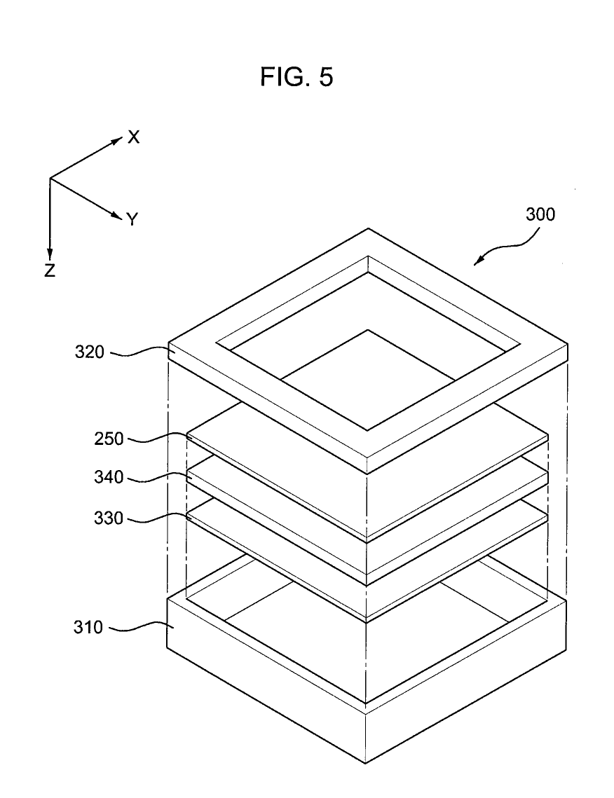

FIG. 5 is a view illustrating a display device.

Referring to FIG. 5, a PDP device can include a case 310, a cover 320 covering the case 310, a driving circuit board 330 housed in the case 310, a panel assembly 340 which includes light emitting cells in which gas discharge is generated and displays an image, and the filter 250 which is installed in front of the panel assembly. The electromagnetic wave blocking layer 276 of the filter 250 can be grounded through the cover to the case 310.

Although the present invention has been described with respect to the PDP filter and the PDP device as an example for convenience's sake, this is not intended to limit the present invention. The filter according to the present invention is applicable to a variety of display devices such as an LCD device, an OLED device, a FED device and so on as well as the PDP device.

What is claimed is:

1. An external light blocking film comprising:
a base transmitting external light, and an external light blocking pattern which blocks the external light and is formed at the base,
wherein a refraction index of the base is larger than a refraction index of air by more than 0 and not more than 0.56, and
the base satisfies the following equation:
0°<(θ1−θ2)≦35°,
where θ1 is an incident angle at which the external light is incident onto the base and θ2 is a refraction angle at which the external light refracts due to a difference between the refraction index of the base and the refraction index of air.

2. The external light blocking film of claim 1 further comprising a backing,
wherein the base is formed on the backing and the backing supports the base.

3. The external light blocking film of claim 1,
wherein the external light blocking pattern includes 100 parts by weight of a light curable resin and 0.5 to 10 parts by weight of a colorant.

4. A filter for a display device comprising an external light blocking film,
wherein the external light blocking film includes a base transmitting external light, and an external light blocking pattern which blocks the external light and is formed at the base,
a refraction index of the base is larger than a refraction index of air by more than 0 and not more than 0.56, and
the base satisfies the following equation:
0°<(θ1−θ2)≦35°,
where θ1 is an incident angle at which the external light is incident onto the base and θ2 is a refraction angle at which the external light refracts due to a difference between the refraction index of the base and the refraction index of air.

5. The filter of claim 4 further comprising a color compensation layer on the external light blocking film.
